(19) United States
(12) Patent Application Publication
(10) Pub. No.: US 2004/0205797 A1
(43) Pub. Date: Oct. 14, 2004

(54) Disk device

(76) Inventor: Masaki Kobayashi, Hyogo (JP)

Correspondence Address: BIRCH STEWART KOLASCH & BIRCH, PO BOX 747, FALLS CHURCH, VA, 22040-0747, US

(21) Appl. No.: 10/694,177

(22) Filed: Oct. 28, 2003

(30) Foreign Application Priority Data
Jan. 9, 2003 (JP) 2003-003491

(51) Int. Cl. G11B 17/30; G11B 21/02

(52) U.S. Cl. 720/688; 720/676

(57) ABSTRACT

A disk device in which a plate spring is provided integrally with a protruding portion that extends over obverse surface of a finger portion nearer to a spindle motor and arrives at a space above a collar portion of a hat-shaped rotor or a turntable when an optical pickup stops at the innermost position of an optical disk M, and a tip portion of the protruding portion is bent in a direction separate from the outer peripheral surface of the hat-shaped rotor. Even if the hat-shaped rotor or the turntable is moved upward when an impact such as excessive vibrations, drop or the like is applied to a disk device, the collar portion abuts against the tip portion of the protruding portion of the plate spring to prevent the rotor from coming off.

### BACKGROUND OF THE INVENTION

1. Field of the Invention

The present invention relates to a disk device which reads a signal recorded in a disk shaped optical recording medium (hereinafter referred to as an optical disk) such as a compact disk (CD) or a digital versatile disk (DVD).

2. Description of the Related Art

As a conventional disk device in the related art, a structure is known in that a turntable on which an optical disk is placed, a damper for clamping a central portion of the optical disk placed on this turntable at the time of recording or reproducing, a spindle motor for rotating the turntable, an optical pickup for reading a signal recorded in the recording layer of the optical disk which is rotated by the spindle motor, and a linear movement unit for reciprocating the optical pickup along a radial direction of the optical disk, are included.

In the conventional disk device, the spindle motor which has a certain measure of thickness (in the direction of a rotary shaft) can be used if the device has enough room in its inner space. In such spindle motor of the kind a mechanism is furnished to prevent a rotor from coming off in the direction of a rotary shaft.

By the way, a desire for reducing a thickness of the disk device has been growing in recent years, for example, because it is necessary to save a space required for mounting the disk device in an automobile. In order to respond to this desire, a spindle motor with low profile has been developed. This spindle motor is generally structured of a rotary shaft, a stator having a plurality of iron cores which extend outward radially from outside of bearing part of this rotary shaft in the radial direction thereof and on which coils are individually wound thereon, and a hat-shaped rotor that covers over this stator and has a cylindrical shape with closed end. This hat-shaped rotor is held to the stator side by a magnetic attractive force and made capable to be rotated by electromagnetic induction.

At this point, the above mentioned low-profile spindle motor does not have enough space where the mechanism for preventing the rotor from coming off in the direction of the rotary shaft, is placed. At the same time, a gap through which the disk is carried exists always between the damper and the turntable above the above mentioned spindle motor except when recording or reproducing is performed. For this reason, there is a fear that the rotor comes off upward in the direction of the rotary shaft and hence recording or reproducing operations fall into impairment when an impact such as excessive vibrations, drop or the like is applied to the disk device.

As a countermeasure against this impairment, in the conventional disk device, another member which is designed specifically for preventing the rotor from coming off, is newly provided (for example, see patent document 1).

[Patent document 1] Japanese Unexamined Patent Publication No. 9-128880 (FIG. 1 and FIG. 3)

Further, in the conventional disk device, when the device is switched from a state of recording or reproducing to a state of ejecting in which the optical disk is ejected, a reverse current is passed through the spindle motor to quickly stop the rotation of the optical disk. This quick stop operation, however, raises a possibility of shortening a life of the spindle motor.

The conventional disk device has the above mentioned structure. Thus, the device has a problem that the number of parts and the number of assembling man-hours are increased and hence costs is greatly increased when another member which is designed specifically for preventing the rotor from coming off is provided as the mechanism for preventing the rotor from coming off.

### SUMMARY OF THE INVENTION

The present invention has been made to solve the above mentioned problems. It is an object of the present invention to provide a disk device which prevents with reliability a rotor from coming off at a low cost.

Moreover, it is another object of the present invention to provide a disk device which is capable of stopping a spindle motor with reliability without passing a reverse current through the spindle motor even when the device is switched from a state of recording or reproducing to a state of ejecting.

A disk device in accordance with the present invention includes: a rotation unit for rotating an optical disk; an optical pickup for reading a signal recorded in the optical disk rotated by the rotation unit; a linear movement unit for reciprocating the optical pickup in a radial direction of the optical disk; a collar portion protruding outward in a radial direction of the rotation unit; and a plate spring that is arranged on the optical pickup and has a protruding portion which reaches a space above the collar portion when the optical pickup stops at the innermost position of the optical disk.

Therefore, according to the present invention, even if a rotor of the rotation unit is moved upward when an impact such as excessive vibrations, drop or the like is applied to the disk device, the collar portion abuts against the tip portion of the protruding portion of the plate spring, so that the disk device produces an effect of preventing rotor of the rotation unit from coming off with reliability. Moreover, the present invention is so structured as to utilize the plate spring as a mechanism for preventing the rotor from coming off, so that the disk device produces an effect of eliminating the need for providing another member specifically designed for preventing the rotor from coming off, as is usual in the related art, and hence realizing a cost down by preventing a cost increase caused by an increase in the number of parts and in the number of assembling man-hours.

### BRIEF DESCRIPTION OF THE DRAWINGS

FIG. 1 is a schematic perspective view to show an outside structure of a disk device in accordance with embodiment 1 of the present invention.

FIG. 2 is a schematic perspective view to show an inside structure of the disk device shown in FIG. 1 in a state which an optical disk is ejected.

FIG. 3 is a schematic perspective view to show an inside structure of the disk device shown in FIG. 1 and FIG. 2 in a state which an optical disk is recorded or reproduced.

FIG. 4 is a schematic enlarged perspective view to show a relevant portion of the disk device shown in FIG. 1 to FIG. 3.

FIG. 5 is a schematic plan view to show a motion of protruding part of a plate spring with regard to a rotation unit of the disk device shown in FIG. 1 to FIG. 4.

FIG. 6 is a schematic front view to show the motion of protruding part of the plate spring with regard to the rotation unit of the disk device shown in FIG. 1 to FIG. 4.

FIG. 7 is a schematic front view to show the motion of protruding part of a plate spring with regard to the rotation unit of a disk device in accordance with embodiment 2 of the present invention.

FIG. 8 is a schematic enlarged perspective view to show a relevant portion of a disk device in accordance with embodiment 3 of the present invention.

FIG. 9 is a schematic front view to show partially in cross section, the motion of protruding part of a plate spring with regard to the rotation unit of the disk device shown in FIG. 8.

FIG. 10 is a schematic front view to show partially in cross section, the motion of protruding part of a plate spring with regard to the rotation unit of a disk device in accordance with embodiment 4 of the present invention.

### DETAILED DESCRIPTION OF THE PREFERRED EMBODIMENTS

Hereinafter the preferred embodiments of the present invention will be described.

### Embodiment 1

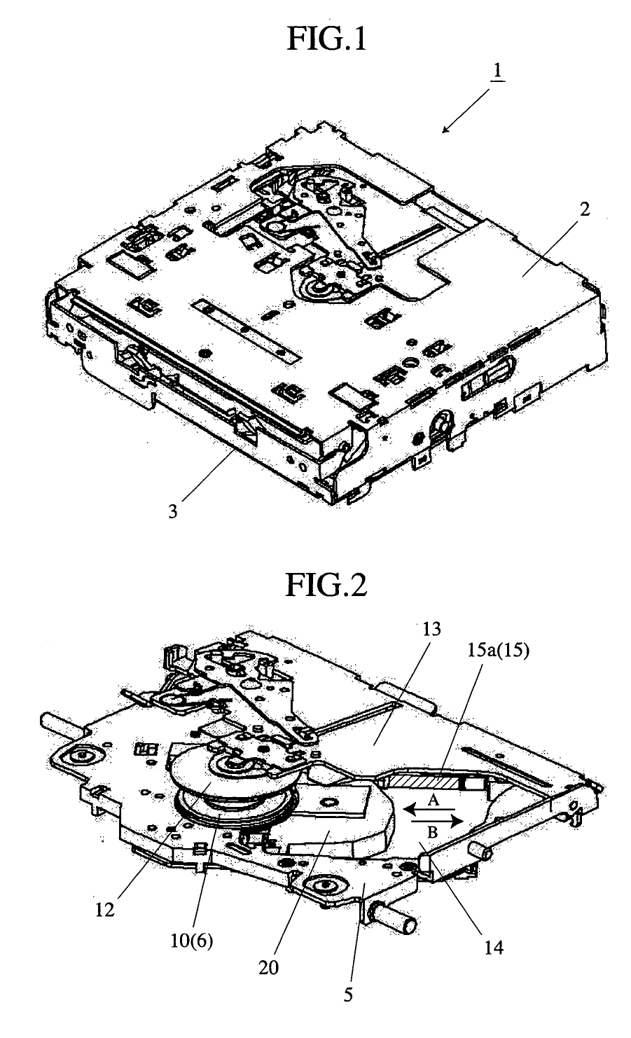

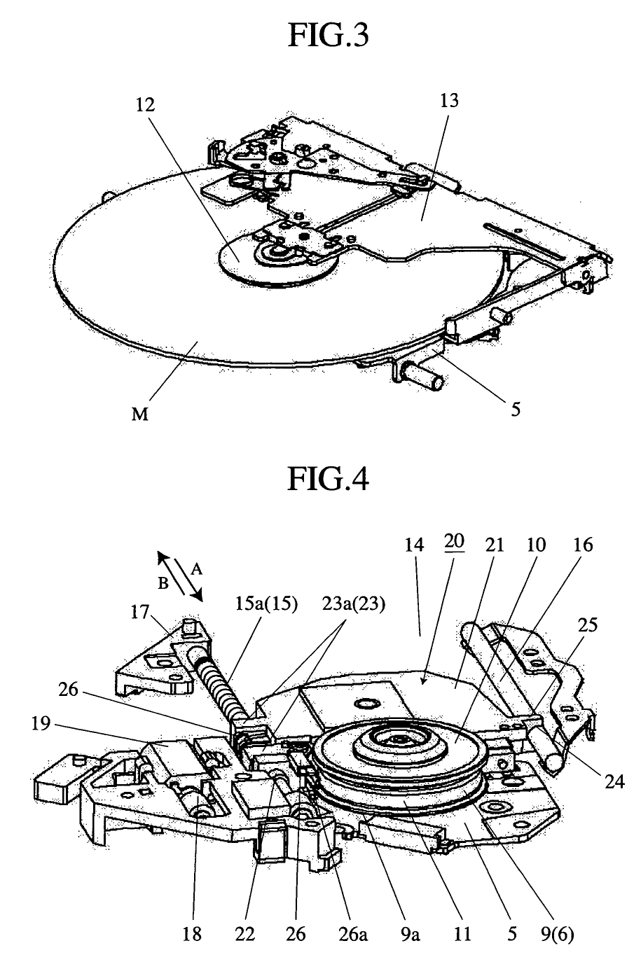

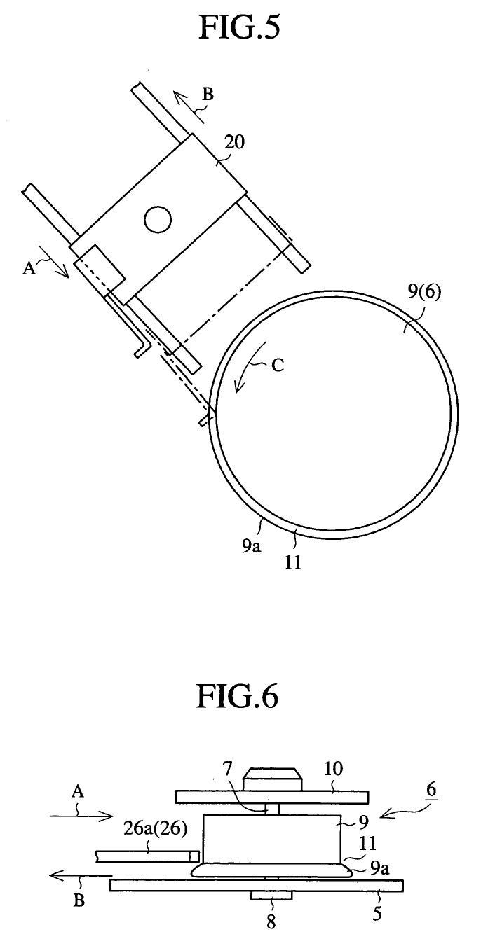

FIG. 1 is a schematic perspective view to show an outside structure of a disk device in accordance with embodiment 1 of the present invention. FIG. 2 is a schematic perspective view to show an inside structure of the disk device shown in FIG. 1 in a state which an optical disk is ejected. FIG. 3 is a schematic perspective view to show an inside structure of the disk device shown in FIG. 1 and FIG. 2 in a state which an optical disk is recorded or reproduced. FIG. 4 is a schematic enlarged perspective view to show a relevant portion of the disk device shown in FIG. 1 to FIG. 3. FIG. 5 is a schematic plan view to show the motion of protruding part of a plate spring with regard to a rotation unit of the disk device shown in FIG. 1 to FIG. 4. FIG. 6 is a schematic front view to show the motion of protruding part of a plate spring with regard to the rotation unit of the disk device shown in FIG. 1 to FIG. 4. At this point, in the respective FIGS. 1 to 3, the disk device is shown in a manner that a left and slanting front side is a front side of the device and that a right and slanting rear side is a rear side of it. Then, in the respective FIGS. 4 and 5, it is shown in a manner that a right and slanting front side is a front side of the device and that a left and slanting rear side is a rear side of it. Further, in FIG. 6, the device is shown in a manner that the right side is a front side the device and that the left side is a rear side of it.

The disk device 1 has a box shaped chassis 2. A slot 3 through which an optical disk M is inserted and ejected, as shown in FIG. 1, is provided in the front of the chassis 2. Then, a base metal plate 5, as shown in FIG. 2 to FIG. 4, is provided in the chassis 2. A spindle motor (rotation unit) 6 is arranged on this base metal plate 5.

The spindle motor 6, as shown in FIG. 6, is generally structured of a rotary shaft 7, a bearing part 8 which rotatably supports this rotary shaft 7, a stator (not shown) which is arranged on the above mentioned base metal plate 5, and a hat-shaped rotor that covers over this stator (not shown) and has a cylindrical shape with closed end. The above mentioned stator (not shown) is generally structured of a bearing part (not shown), a plurality of iron cores (not shown) each of which extends outward radially from outer periphery of this bearing part in the radial direction of the iron core and has an individual coil (not shown) wound thereon, and an arc-shaped guide (not shown) which is provided on the outermost portions of these iron cores and which is extended in the peripheral direction of the iron cores to thereby guide rotational motion of the above mentioned hat-shaped rotor 9. This hat-shaped rotor 9 is held to the stator (not shown) side by a magnetic attractive force and can be rotated by magnetic induction.

A turntable 10 on which the optical disk M is placed, is integrally fixed via the rotary shaft 7, to the top of the hat-shaped rotor 9. This turntable 10 can be rotated synchronously with the hat-shaped rotor 9. Then, on the outer peripheral surface of the hat-shaped rotor 9, as shown in FIG. 6, is formed a collar portion 9a which protrudes outward in the radial direction and continues in the peripheral direction. An upper space 11 along the outer peripheral surface of the hat-shaped rotor 9 is formed above the collar portion 9a.

A damper 12 for clamping central portion of the optical disk M, for example, as shown in FIG. 2 and FIG. 3, is arranged above the top of the turntable 10. This damper 12 is fixed in such a way that it can swing, to the tip portion of a press arm 13 which can press the damper 12 to the turntable 10 side.

Then, in the base metal plate 5, an inner space 14 is provided at a position adjacent to the spindle motor 6 and a screw shaft (linear movement unit) 15 and a guide shaft (linear movement unit) 16 which are parallel to each other, are arranged toward the spindle motor 6 side. The screw shaft 15 has an outside surface on which a threaded groove 15a is continuously formed, and one end of the screw shaft 15 is rotatably supported by a bearing part 17 and the other end is connected via a power transmitting gear train (linear movement unit) 18 to a drive motor (linear movement unit) 19.

An optical pickup 20 is arranged on the screw shaft 15 and the guide shaft 16 in such a way that they can freely slide in the directions indicated by the arrows A and B in FIG. 4. The optical pickup 20 is generally structured of a case 21, a first arm portion 23 that is formed on the screw shaft 15 side of this case 21 and has a through hole 22 allowing the screw shaft 15 to pass, and a second arm portion 25 that is formed on the guide shaft 16 side of the case 21 and has a through hole 24 allowing the guide shaft 16 to pass. In the case 21 an objective lens (not shown) for applying an optical beam which is obtained by gathering light from an light source (not shown) such as a light emitting diode arranged on the base metal plate 5, to a recording layer (not shown) of the optical disk M, and a focus tracking control mechanism (not shown) performing a focus operation and a tracking operation to this objective lens (not shown), are included. The first arm portion 23 has two finger portions 23a that are spaced in the axial direction of the screw shaft 15, and then a plate spring 26 that is mounted on the first arm portion 23 and has an convex part (not shown) pressed onto and engaged with the threaded groove 15a of the screw shaft 15 is disposed between both of the finger portions 23a.

The plate spring 26 is provided integrally with a protruding portion 26a that extends over obverse surface of the finger portion 23a nearer to the spindle motor 6 and arrives at the upper space 11 above the collar portion 9a of the hat-shaped rotor 9 when the optical pickup 20 stops at the position nearest to the spindle motor 6 (the innermost position of the optical disk M). A tip portion of the protruding portion 26a, as shown in FIG. 5, is bent in a direction separate from the outer peripheral surface of the hat-shaped rotor 9 which rotates in the direction indicated by the arrow C in order to enhance its mechanical strength.

Next, operation will be described.

First, in the disk device 1, the optical pickup 20 always stops at the innermost position of the optical disk M except when it performs recording or reproducing. At this time, the tip portion of protruding portion 26a of the plate spring 26 arranged on the optical pickup 20 reaches the upper space 11 above the collar portion 9a of the hat-shaped rotor 9. On the other hand, a gap through which the disk M is carried, always exists between the damper 12 and the turntable 10 above the spindle motor 6, except when the pickup 20 performs recording or reproducing.

Here, when an impact such as excessive vibrations, drop or the like is applied to the disk device 1, there is a possibility that the hat-shaped rotor 9 is moved upward in the direction of the rotary shaft, that is, to the above mentioned gap side along with the turntable 10. Even when the hat-shaped rotor 9 is moved upward, the collar portion 9a abuts against the tip portion of the protruding portion 26a of the plate spring 26, so that the hat-shaped rotor 9 can be prevented from coming off with reliability.

As described above, according to this embodiment 1, the plate spring 26 is so structured as to have the protruding portion 26a that reaches the upper space 11 above the collar portion 9a of the hat-shaped rotor 9 when the optical pickup 20 stops at the innermost position of the optical disk M. Thus, even if the hat-shaped rotor 9 is moved upward when the impact such as the excessive vibrations, drop or the like is applied to the disk device 1, the collar portion 9a abuts against the tip portion of the protruding portion 26a of the plate spring 26. Therefore, the disk device 1 has an effect of preventing the hat-shaped rotor 9 from coming off with reliability.

This embodiment 1 is so structured as to utilize the plate spring 26 as a mechanism for preventing the hat-shaped rotor 9 from coming off, so that this embodiment 1 eliminates the need for providing another member specifically designed for preventing the hat-shaped rotor 9 from coming off, as is usual in the related art, and hence produces an effect of preventing a cost increase caused by an increase in the number of parts and the number of assembling man-hours.

### Embodiment 2

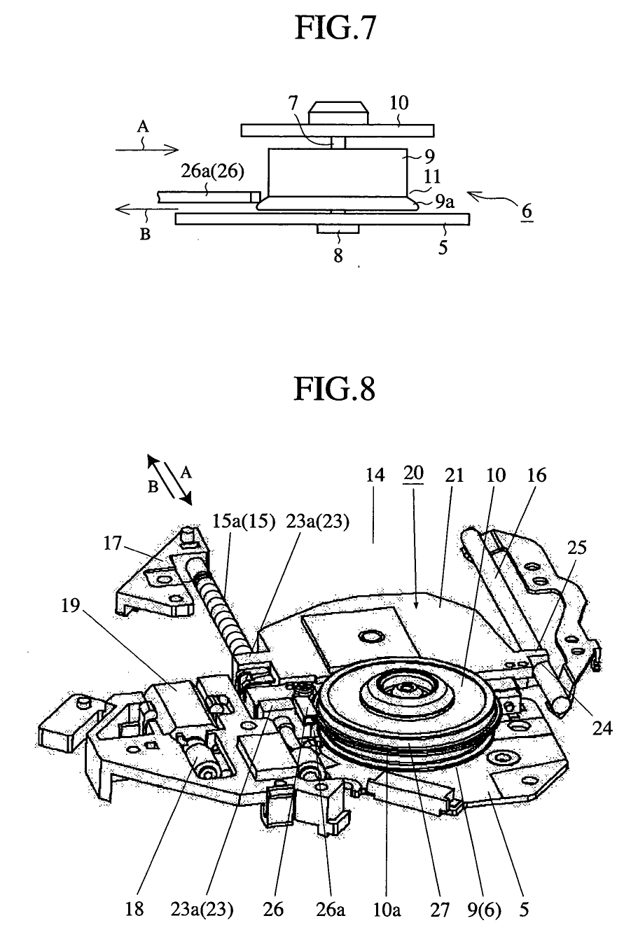

FIG. 7 is a schematic front view to show the motion of protruding part of a plate spring with regard to the rotation unit of a disk device in accordance with embodiment 2 of the present invention. Here, of the constituent parts of this embodiment 2, those parts which are common to the constituent parts in the embodiment 1 are denoted by the same reference symbols and their further descriptions will be omitted. At this time, in FIG. 7, it is shown in a manner that the right side is a front side and that the left side is a rear side.

The feature of this embodiment 2 lies in that the plate spring 26 is provided, which has the protruding portion 26a abutting against upper portion of the collar portion 9a of the hat-shaped rotor 9 in a case where the device is switched from a state of recording or reproducing to the state of ejecting.

Next, operation will be described.

First, when the optical pickup 20 performs recording or reproducing, the optical pickup 20 is reciprocated in the directions indicated by the arrows A and B in FIG. 7 by the drive motor 19 to perform recording or reproducing to the optical disk M. In a case where the device is switched from this state of recording or reproducing to the state of ejecting in which the optical disk M is ejected, a power distribution to the spindle motor 6 is stopped and at the same time the optical pickup 20 is quickly moved in the direction indicated by the arrow A by the drive motor 19 to return itself to the innermost position of the optical disk M to thereby make a tip portion of protruding portion 26a of the plate spring 26 abut against an upper portion of the collar portion 9a of the hat-shaped rotor 9. With this operation, the spindle motor 6 is stopped with reliability without a quick stop operation which, as is usual in the related art, is performed by passing a reverse current through the spindle motor 6.

As described above, according to this embodiment 2, the plate spring 26 is so structured as to have the protruding portion 26a that abuts against upper portion of the collar portion 9a of the hat-shaped rotor 9 in a case where the device is switched from the state of recording or reproducing to the state of ejecting. Thus, even when the device is switched from the state of recording or reproducing to the state of ejecting, this device 1 produces an effect of stopping the spindle motor 6 with reliability without passing the reverse current through the spindle motor 6. Therefore, this produces an effect of elongating life of the spindle motor 6.

### Embodiment 3

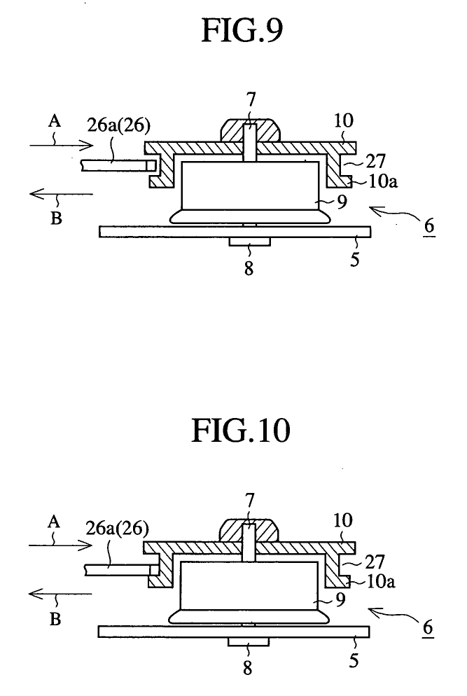

FIG. 8 is a schematic enlarged perspective view to show a relevant portion of a disk device in accordance with embodiment 3 of the present invention, and FIG. 9 is a schematic front view to show a motion of the protruding part of plate spring partially in cross section with regard to the rotation unit of the disk device shown in FIG. 8. Here, of the constituent parts of this embodiment 3, those parts which are common to the constituent parts in the embodiment 1, are denoted by the same reference symbols and their further descriptions will be omitted. At this point, in FIG. 8, the disk device is shown in a manner that a right and slanting front side is a front side of the device and that a left and slanting rear side is a rear side of it. Moreover, in FIG. 9, the disk device is shown in a manner that a right side is a front side and a left side is a rear side.

The feature of this embodiment 3 lies in that in place of forming the collar portion 9a on the outer peripheral surface of the hat-shaped rotor 9 in the embodiment 1 and the embodiment 2, a collar portion 10a which protrudes outward in the radial direction and continues in the peripheral direction, is formed on the outer peripheral surface of the turntable 10 that is integrally fixed via the rotary shaft 7 to the hat-shaped rotor 9. That is to say, an upper space 27 at which the protruding portion 26a of plate spring 26 arranged on the optical pickup 20, and which arrives when the optical pickup 20 stops at the innermost position of the optical disk M, is formed above the collar portion 10a.

Next, operation will be described.

First, in the disk device 1, the optical pickup 20 always stops at the innermost position of the optical disk M except when the optical pickup 20 performs recording or reproducing. At this time, a tip portion of protruding portion 26a of the plate spring 26 which is arranged on the optical pickup 20 reaches the upper space 27 above the collar portion 10a of the turntable 10. On the other hand, except when the pickup 20 performs recording or reproducing, a gap through which the disk M is carried, exists between the damper 12 and the turntable 10 above the spindle motor 6.

Here, when an impact such as excessive vibrations, drop or the like is applied to the disk device 1, there is a possibility that the turntable 10 is moved upward in the direction of the rotary shaft, that is, to the above mentioned gap side, along with the hat-shaped rotor 9. Even when the turntable 10 is moved upward, the collar portion 10a abuts against the tip portion of protruding portion 26a of the plate spring 26. Thus, the hat-shaped rotor 9 that is integrally fixed to the turntable 10 can be prevented from coming off with reliability.

As described above, according to this embodiment 3, the plate spring 26 is so structured as to have the protruding portion 26a that reaches the upper space 27 above the collar portion 10a of the hat-shaped rotor 9 when the optical pickup 20 stops at the innermost position of the optical disk M. Thus, even if the turntable 10 is moved upward when the impact such as the excessive vibrations, drop or the like is applied to the disk device 1, the collar portion 10a abuts against the tip portion of protruding portion 26a of the plate spring 26. Therefore, the disk device 1 has an effect of preventing the hat-shaped rotor 9 integrally fixed to the turntable 10 from coming off with reliability.

### Embodiment 4

FIG. 10 is a schematic front view to show partially in cross section, the motion of protruding part of a plate spring with regard to the rotation unit of a disk device in accordance with embodiment 4 of the present invention. Here, of the constituent parts of this embodiment 4, those parts which are common to the constituent parts in the embodiment 1 and the like are denoted by the same reference symbols and their further descriptions will be omitted. Then, in FIG. 10, the disk device is shown in a manner that a right side is a front side and that the left side is a rear side.

The feature of this embodiment 4 lies in that the plate spring is provided, which has the protruding portion 26a abutting against upper portion of the collar portion 10a of the turntable 10 in a case where the disk device is switched from the state of recording or reproducing to the state of ejecting.

Next, operation will be described.

First, when the optical pickup 20 performs recording or reproducing, the optical pickup 20 is reciprocated in the directions indicated by the arrows A and B in the FIG. 10 by the drive motor 19 to perform recording or reproducing to the optical disk M. In a case where the device is switched from this state of recording or reproducing to the state of ejecting in which the optical disk M is ejected, a power distribution to the spindle motor 6 is stopped and at the same time the optical pickup 20 is quickly moved in the direction indicated by the arrow A by the drive motor 19 to return to the innermost position of the optical disk M to thereby make the tip portion of protruding portion 26a of the plate spring 26 abut against upper portion of the collar portion 10a of the turntable 10. With this operation, the spindle motor 6 is stopped with reliability without a quick stop operation which, as is usual in the related art, is performed by passing a reverse current through the spindle motor 6.

As described above, according to this embodiment 4, the plate spring 26 is so structured as to have the protruding portion 26a that abuts against upper portion of the collar portion 10a of the turntable 10 in a case where the disk device is switched from the state of recording or reproducing to the state of ejecting. Thus, even when the disk device is switched from the state of recording or reproducing to the state of ejecting, this embodiment 4 produces an effect of stopping the spindle motor 6 with reliability without passing the reverse current through the spindle motor 6. This produces an effect of elongating life of the spindle motor 6.

What is claimed is:

1. A disk device comprising:
a rotation unit for rotating an optical disk;
an optical pickup for reading a signal recorded in the optical disk rotated by the rotation unit;
a linear movement unit for reciprocating the optical pickup in a radial direction of the optical disk;
a collar portion protruding outward in a radial direction of the rotation unit; and
a plate spring that is arranged on the optical pickup and has a protruding portion which reaches a space above the collar portion when the optical pickup stops at the innermost position of the optical disk.

2. The disk device as claimed in claim 1, wherein the protruding portion of the plate spring abuts against upper portion of the collar portion.

3. A disk device comprising:
a turntable on which an optical disk is placed;
a rotation unit for rotating the turntable;
an optical pickup for reading a signal recorded in the optical disk rotated by the rotation unit;
a linear movement unit for reciprocating the optical pickup in a radial direction of the optical disk;
a collar portion protruding outward in a radial direction of the turntable; and
a plate spring that is arranged on the optical pickup and has a protruding portion which reaches a space above the collar portion when the optical pickup stops at the innermost position of the optical disk.

4. The disk device as claimed in claim 3, wherein the protruding portion of the plate spring abuts against upper portion of the collar portion.
